(19) United States
(12) Patent Application Publication
(10) Pub. No.: US 2018/0125742 A1
(43) Pub. Date: May 10, 2018

(54) Suction Therapy Apparatus

(71) Applicants: Donald Melnikoff, Mukwonago, WI (US); Wayne Siebrecht, Golden, CO (US)

(72) Inventors: Donald Melnikoff, Mukwonago, WI (US); Wayne Siebrecht, Golden, CO (US)

(21) Appl. No.: 15/712,138

(22) Filed: Sep. 22, 2017

Related U.S. Application Data
(60) Provisional application No. 62/405,200, filed on Oct. 6, 2016.

(51) Int. Cl. A61H 9/00

(52) U.S. Cl. CPC A61H 9/0057; A61H 7/00; A61H 2009/0064

(57) ABSTRACT

A manipulation therapy apparatus, system, and method is disclosed which allows a user to perform manual manipulation therapy through traction to a treatment area on their own, to easily control the amount and direction of manipulation without the need for lubrication. The manipulation therapy apparatus comprises a vacuum chamber with a handle and an air cavity, a skin sealing gasket, a pressure relief valve, and a brace.

### CROSS REFERENCE TO RELATED APPLICATIONS

U.S. Provisional application No. 62/405,200, filed on Oct. 6, 2016.

### BACKGROUND OF THE INVENTION

### 1. Field of the Invention

The present invention relates generally to a therapeutic tool for soft tissue and joint manipulation through traction.

### 2. Background

Human beings suffer from a variety of injuries and conditions which cause musculoskeletal pain and disability. Healthcare practitioners such as physical therapists, chiropractors, occupational therapists, and osteopaths routinely treat such injuries and conditions using manual manipulation of joints and soft tissue (including muscles) to reduce pain and increase range of motion of a joint or appendage through stretching and pulling. Such manual manipulation therapy provide increased mobility, flexibility, range of motion, and circulation as well as a reduction in pain, displacement of underlying scar tissue, and reduction in soft tissue tension. Multiple therapy sessions can also help realign joints as well as muscles in order to help further reduce pain.

Physical therapists have been known to use a standard sink plunger to treat a knee during a manual manipulation therapy session. A standard plunger and knee is lubricated and the plunger is applied to the top of the knee in order to create a vacuum seal on the skin at the knee. Once a successful seal is created, the therapist can move the tissue by pulling up (traction), via the handle of the plunger, on the site where the suction is applied and can move or stretch the knee cap around to help with the manual manipulation therapy session. This process is extremely problematic for a number of reasons. First, a patient cannot perform the process on their own and thus need to obtain a second person's help to hold the plunger to the skin to try to create and maintain a seal. Next, liberal lubrication by oil, lotion, or water is required which is not only inconvenient but also messy. Further, a consistent and secure seal cannot be easily made or maintained as any movement of the standard plunger to manipulate the knee ensures the seal between the plunger and skin is broken and all vacuum lost, thereby negating the therapy purpose or benefits all together. Also, the control of direction of traction and amount of the manual manipulation cannot be easily completed thus further reducing the efficacy of such process.

It would be desirable to have a solution which allows practitioners and patients to perform a more effective manual manipulation therapy session by themselves in an easy to use and effective manner without the need for lubricants.

### SUMMARY OF THE INVENTION

The present invention advantageously fills the aforementioned deficiencies by providing an apparatus, system, and method for a person to perform manual manipulation therapy through traction on themselves easily and effectively, thereby promoting healing and reduces symptoms from injury or disability.

Among other things, it is an object of the present invention is to allow a person to conduct their own manual manipulation therapy on their own appendages without the help of others.

Another object of the present invention is to provide a robust seal between the invention and a treatment area.

Another object of the present invention is to provide a robust seal between the invention and a treatment area without the need for lubricants.

Another object of the present invention is to allow a user to control the amount of suction applied to a treatment area.

Another object of the present invention is to allow a user to easily control the direction of suction application to a treatment area.

Another object of the present invention is to allow a user to easily change the direction and application of suction to a treatment area during manual manipulation therapy.

In a first aspect, an apparatus is provided. The apparatus includes a vacuum chamber which further includes a handle cavity and an air cavity connected to each other. The air cavity has a closed end and an open end with an outward facing lip. The apparatus also includes a first gasket of a first durometer affixed to the top of the outward facing lip, a second gasket of a second durometer affixed to the bottom of the outward facing lip, a pressure relief valve affixed to the vacuum chamber, and a fabric brace configured to wrap firmly around a human appendage. The fabric brace has a top surface, a bottom surface, and a recess configured for holding materials. The fabric brace holds the vacuum chamber, first gasket, and second gasket in place on a human appendage. The handle cavity and air cavity of the vacuum chamber extend through the recess away from the top surface while the first gasket touches the bottom surface and extends away from the bottom surface along with the second gasket and outward facing lip.

In a second aspect, a system is provided. The system comprises a manipulation therapy apparatus comprising a vacuum chamber, a first gasket of a first durometer affixed to the top of the outward facing lip, a second gasket of a second durometer affixed to the bottom of the outward facing lip, a tube connection affixed to the vacuum chamber, and a fabric brace configured to wrap firmly around a human appendage; a vacuum pump configured to create and maintain a vacuum within the vacuum chamber of the manipulation therapy apparatus; and a tube; wherein one end of the tube removably connects to the vacuum chamber and the other end connects to the vacuum pump. The vacuum chamber of the manipulation therapy apparatus further comprises a handle cavity connect to an air cavity having an open end, wherein the open end comprises an outward facing lip. The fabric brace of the manipulation therapy apparatus further comprising a top surface, a bottom surface, and a recess configured for holding materials, wherein the handle cavity and air cavity of the vacuum chamber extend through the recess away from the top surface while the first gasket touches the bottom surface and extends away from the bottom surface along with the circular gasket and the outward facing lip.

In a third aspect, a method is provided. The includes first securing a manipulation therapy apparatus comprising a vacuum chamber further comprising a handle and an air cavity, a first gasket, second gasket, a pressure release valve, and a wrap on a treatment area to a human appendage. Second, centering the vacuum chamber over a treatment area of the appendage. Third, securing the wrap around the appendage. Fourth, pushing down on the vacuum chamber via the handle to evacuate air inside the chamber. Finally, pulling the handle in at least one direction for a period of time to manipulate the treatment area.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1. is a side partial-section view of an embodiment of the present invention along the line 1-1 of FIG. 2 looking in the direction of the arrows.

FIG. 2. is a top perspective view of an embodiment of the present invention.

FIG. 3. is a bottom perspective view of an embodiment of the present invention.

FIG. 4. is a top perspective view of an embodiment of the present invention secured to a treatment area.

FIG. 5. is a top perspective view of an embodiment of the present invention.

FIG. 6. is an embodiment of the present invention as a system.

### DETAILED DESCRIPTION OF THE INVENTION

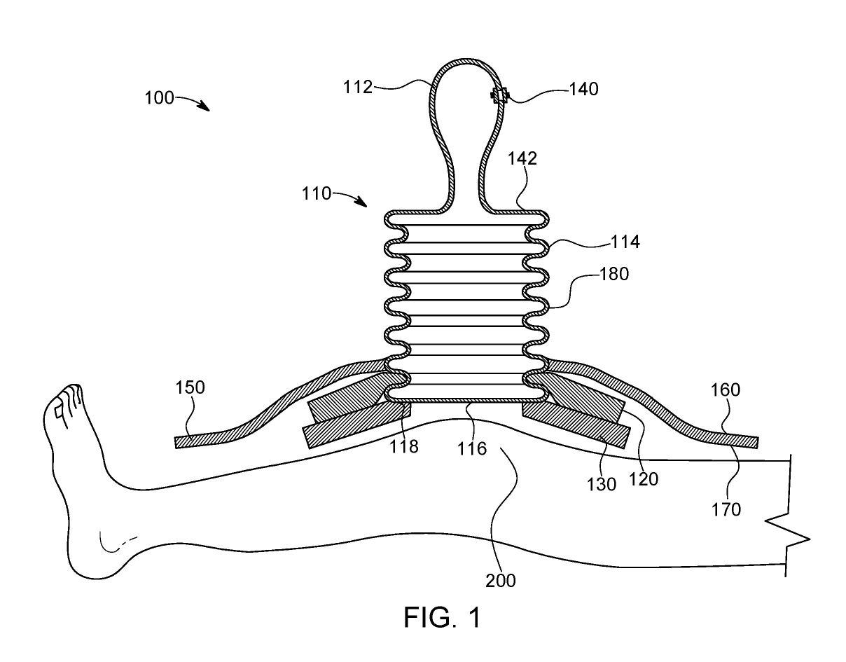

A manipulation therapy apparatus, system, and method will now be described with references in FIGS. 1-6. Turning to the drawings, where the reference characters indicate corresponding elements throughout the several figures, attention is first directed to FIG. 1 where a side partial-section view of a preferred embodiment of a manipulation therapy apparatus is shown, illustrating its composition and the apparatus is generally indicated by reference character 100. The apparatus 100 comprises a vacuum chamber 110, a first gasket 120, a second gasket 130, a pressure relief valve 140, and a brace 150. Apparatus 100 creates a vacuum pressure within vacuum chamber 110 via an airtight seal with a treatment area 200 on a human appendage through physical contact between skin at area 200 and second seal 130, allowing a user to physically manipulate at least the soft tissue or joint of a treatment area 200 through application and manipulation of the vacuum pressure within apparatus 100 by themselves as well as control the direction of the vacuum pressure applied to treatment area 200, and duration of the physical manipulations conveniently and effectively without the need for lubrication such as water, creams, or oils, thereby allowing a user to obtain all the benefits of manual manipulation therapy.

Vacuum chamber 110 is comprised of a handle 112 and an air cavity 114. Air cavity 114 is further comprised of a closed end 142 and an open end 116. Open end 116 further comprises an outward facing lip 118 located about open end 116. Handle 112 is ideally the shape of a singular protrusion, such as a cylinder, formed integral with air cavity 114 and extending from closed end 142, however handle 112 could also be separate from but connected to air cavity 114. Handle 112 is preferably located centrally on closed end 142. Further, handle 112 is preferably hollow on the inside so that handle 112 and air cavity 114 act as one singular cavity, providing an area to create a vacuum pressure as well as making mass production of such elements economical. It is contemplated handle 112 could be any shape common to such handles which allow a user to grasp and operate vacuum chamber 110 easily, such as a knob, loop, or hook. Handle 112 is manipulated by a user to operate apparatus 100 when, after apparatus is secured to a treatment area, the user first pushes handle 112 toward air cavity 114 and treatment area 200, expunging any air inside vacuum chamber 110 through pressure relief valve 140 and creates a vacuum pressure inside chamber 110. The user then pulls handle 112 away from air cavity 114 and treatment area 200 in the direction desired by the user, thereby applying the vacuum pressure to treatment area 200 and pulling or stretching treatment area 200 as long as the user maintains a pulling force on handle 112, thereby manipulating soft tissue or a joint at the treatment area. A user can then release handle 112 and a vacuum pressure will be maintained on treatment area 200. A user can then either pull on handle 112 in the desired direction again, or repeat the same push/pull action again to reestablish the vacuum pressure, or suction, on treatment area 200, such as in a case where air bled out of vacuum chamber 110 during a previous manipulation. Further, by changing the orientation of handle 112 the direction of vacuum pressure applied to treatment area 200 can be altered during or between each pull or push/pull cycle, thereby providing a user the ability to stretch and manipulate a treatment area 200 from various directions, thereby enhancing the benefits associated with manipulation treatment therapy such as reduced pain and quicker healing of the treatment area. In addition, wrap 150, first gasket 110, and second gasket 120 all act to help create and maintain an airtight seal between second gasket 130 and treatment area 200, which ensures the vacuum pressure inside vacuum chamber 110 is maintained to provide the therapy. Initially an airtight seal is created when wrap 150 is fastened around the human appendage at treatment area 200, wherein vacuum chamber 110 is centered over the desired treatment area and second gasket 130 is brought into physical contact with the treatment area. A user then pushes handle 112 toward treatment area 200 at least one time to remove an amount of air from air vacuum chamber 110 through pressure relief valve 140 and creating a vacuum pressure within vacuum chamber 110 for application to treatment site 200.

Air cavity 114 is ideally tubular bellows shaped as this shape creates the desired vacuum pressure with a minimal amount of effort of the user while also allowing movement of cavity 114 via handle 112 then a traditional semi-spherical air cavity would. However, it is contemplated other shapes and configurations of the air cavity may be employed which create the desired vacuum pressure and movement requirements described herein, one example is a tapering tubular bellows shape, that is, a generally tubular shape with bellows of varying outer diameters. Further, it is contemplated air cavity 114 may be longer as it may be desirable to increase the vacuum pressure applied to a treatment area, and creating a longer or wider air cavity is one way to accommodate such a goal, however the outer diameter of air cavity 114 is generally limited by size of the desired treatment area, such as a knee cap.

Outward facing lip 118 surrounds open end 116 and is preferably formed integral with air cavity 114. Lip 118 is of sufficient width, ideally at least 0.125 inches, to allow first gasket 120 to be affixed securely to the top of lip 118 and second gasket 130 to be affixed securely to the bottom of lip 118, thereby allowing an airtight seal to be made between vacuum chamber 110 and treatment area 200. If air cavity 114 is a tubular bellows shape, as shown in FIGS. 1-6, the outward facing lip 118 may be a singular bellow closest to open end 116 of air cavity 114. Outward facing lip 118 is ideally affixed securely to first gasket 120 and second gasket 130 by an adhesive adequate to secure foam or rubber to plastic. It is contemplated first gasket 120 and second gasket 130 may be secured to lip 118 by overmolding gaskets 120 and 130 to lip 118. It is further contemplated first gasket 120 and second gasket 130 may be configured to secure outward facing lip 118 and thus vacuum chamber 110 to wrap 150 without an adhesive and still maintain an airtight seal between vacuum chamber 110 and the skin at treatment area 200. Air cavity 114 is ideally made of a flexible plastic material commonly used by injection molding machinery for repetitive use objects allowing the inexpensive and mass production of the unit, such as those comprised of thermoplastic or thermosetting polymers and of a thickness which allows repetitive and long term use, such as 0.004 inches.

Vacuum chamber 110 is ideally 6.5 inches tall where air cavity 114 is 3.5 inches tall and handle 112 is 3 inches tall and 0.7 inches in diameter, with air cavity 114 having an outer diameter of at least 3 inches, and comprised of seven bellows each 0.25 inches thick with an inner diameter of at least 2 inches (preferably 3 inches) and outer diameter between 2.5 inches to 3.75 inches. These dimensions are ideal as they allow chamber 110 to establish and maintain a desired vacuum pressure of at least 1 PSIV (50 mmHg), with a desired, or ideal, range of 1 PSIV to 5 PSIV (50 mmHg-250 mmHg), when in contact with a treatment area, thereby providing sufficient vacuum pressure to manually manipulate a treatment area as well as ensure apparatus 100 is convenient, portable, and provide manipulation of the desired treatment area which also provides at least subjective pain relief to the user of the treatment area after the therapy is completed either in a single session or from multiple therapy sessions.

Pressure relief valve 140 is affixed to vacuum chamber 110 either on handle 112 or on a closed end 142 of air cavity 112. The location of valve 140 is important as it needs to be such that it will not obstruct a user during use of the apparatus. Further, valve 140 allows air to be expunged from vacuum chamber 110 through compression of air chamber 114 by a user through handle 112, thereby making an airtight seal between treatment area 200 and open end 116 of air cavity 114 and creating the desired vacuum pressure for application to treatment area 200 for manual manipulation easily, conveniently, and consistently. Valve 140 is ideally a 0.125 inch passive one-way valve with a spring pressure of 0.7 PSI, of the type including but not limited to duckbill, umbrella, minivalveballs, dome, belleville, or cross-slit valves. A spring pressure of 0.7 PSI provides, in the preferred embodiment, a vacuum pressure within chamber 110 when handle 112 is pulled, a vacuum pressure inside the chamber within the desired range of 1 PSIV to 5 PSIV. It is contemplated valve 140 may be adjustable to allow a user to control the vacuum pressure level inside vacuum chamber 110 and thus applied to treatment area 200. Further, the spring pressure of valve 140 may be changed to accommodate a different configuration of vacuum chamber 110, which may include a different choice in manufacturing material, thereby making compression of air cavity 114 require more or less force exerted by a user.

It is contemplated the size of vacuum chamber 110 may be altered to accommodate a configuration convenient and suited for application to a specific treatment area as long as chamber 110 can exert an air pressure of at least 0.7 PSI on a treatment area from a compression of air cavity 114 by a user via handle 112 and can establish and maintain a vacuum pressure, or suction, on treatment area of at least 1 Psi, with an ideal range of 1 PSIV to 5 PSIV.

First gasket 120 is positioned between wrap 150 and the top of outward facing lip 118 in order to secure vacuum chamber 110 to treatment area 200 and maintain an airtight seal between second gasket 130 and treatment area 200. First gasket 120 and second gasket 130 are both ideally circular shaped to mirror the circular shape of open end 116 and both have an inner diameter less than or equal to the outer diameter of air cavity 114 however other shapes such as a square or other geometric shape is contemplated as long as the purpose of first gasket 120 is maintained. Preferably first gasket will have an inner diameter of 2.76 inches and an outer diameter of 5.9 inches, but it is contemplated the inner diameter of first gasket 120 may change if the diameter of open end 116 of vacuum chamber 110 is changed. An inner diameter size of 2.76 inches is an ideal size for a treatment surface area comprising an average person's kneecap, but could be adjusted to accommodate other treatment areas or specific population physicalities. Second gasket 130 is positioned below first gasket 120 and outward facing lip 118 and aids to create an airtight seal between treatment area 200 and open end 116 of vacuum chamber 110. As such, second gasket 130 is generally a lower durometer, or softer, than first gasket 120 in order to more easily ply to the skin about treatment site 200 and create the airtight seal easier. It is important for first gasket 120 to be a higher durometer, or stiffer, than second gasket 120 in order to prevent brace 150 from moving or wrinkling near vacuum chamber 110, causing the airtight seal between vacuum chamber 110 and treatment area 200 to be easily broken, during a therapy session from to the manipulation of vacuum chamber 110 by a user. Further, in the preferred embodiment second gasket 130 has the same inner diameter of first gasket 120 of 2.76 inches but has an outer diameter of 6.3 inches. The outer diameter of second gasket 130 is larger than the outer diameter of first gasket 120 in order to more easily create and effectively maintain the desired airtight seal between treatment area 200 and the open end 116 of air cavity 114. Second gasket 130 is preferably adhered to first gasket 120 and the bottom of outward facing lip 118, thereby enclosing outward facing lip 118 between first gasket 120 and second gasket 130. First gasket 120 is ideally made from polypropylene foam and second gasket 130 is made from polychloroprene but it is contemplated either gasket can be comprised of foam or rubber material, natural or synthetic, such as closed cell foam or open cell foam, including polychloroprene, polypropylene, and thermoplastic vulcanizate as long as the purposes and size proportions of first gasket 120 and second gasket 130 are maintained. First gasket 120 is ideally 0.125 inches in thickness and second gasket 130 is ideally between 0.125 inches and 0.5 inches thick but either gasket could be a different thickness as long as the purposes of first gasket 120 and second gasket 130 are maintained. First gasket 120 and second gasket 130 are permanent adhered together by an adhesive suitable to adhere lightweight foam or rubbers together, such as 3M® Super 77® Multipurpose adhesive spray, but it is contemplated other adhesion methods could be used, such as by heat sealing, ultrasonic welding, or chemical/solvent bonding. In addition, first gasket 120 and second gasket 130 could be molded as a single layer gasket. The difference in the durometer and outer diameter of first gasket 120 and second gasket 130 allows the airtight seal between vacuum chamber 110 and the skin at treatment area 200 to be created without the need for lubricant such as oils or gels as well as maintained easily while manipulation of the treatment site is effected through use of vacuum chamber 110 by a single user.

Brace 150 is comprised of a fabric with a top surface 160, a bottom surface 170, and a recess configured for holding materials 180 with a diameter less than or equal to the inner diameter of air cavity 114 and less than the outer diameter of first gasket 120, although it is contemplated recess 180 configured for holding materials may be slightly larger or smaller, ideally up to 10%, then inner diameter of air cavity 114 as brace 150 may be, but is not required to be, comprised of elastic material commonly used for appendage braces, such as synthetic stretch fabric. Brace 150 ensures vacuum chamber 110 establishes and maintains an airtight seal with treatment site 200 while a user manipulates the treatment site via handle 112 as well as ensures consistent positioning of vacuum chamber 110 over treatment area 200 by wrapping firmly around a human appendage and securing vacuum chamber 110 to treatment area 200. The purpose of recess configured for holding materials 180 is to secure the position of vacuum chamber 110 over treatment area 200 and to maintain an airtight seal between vacuum chamber 110 and treatment area 200 during therapy. Further, handle 112 and air cavity 114 extend through recess configured for holding materials 180 away from top surface 160 while open end 116 and outward facing lip 118 of air cavity 114 extend away from the bottom surface 170 of brace 150. Further, first gasket 120 and second gasket 130 are located near bottom surface 170, where first gasket 120 touches bottom surface 170.

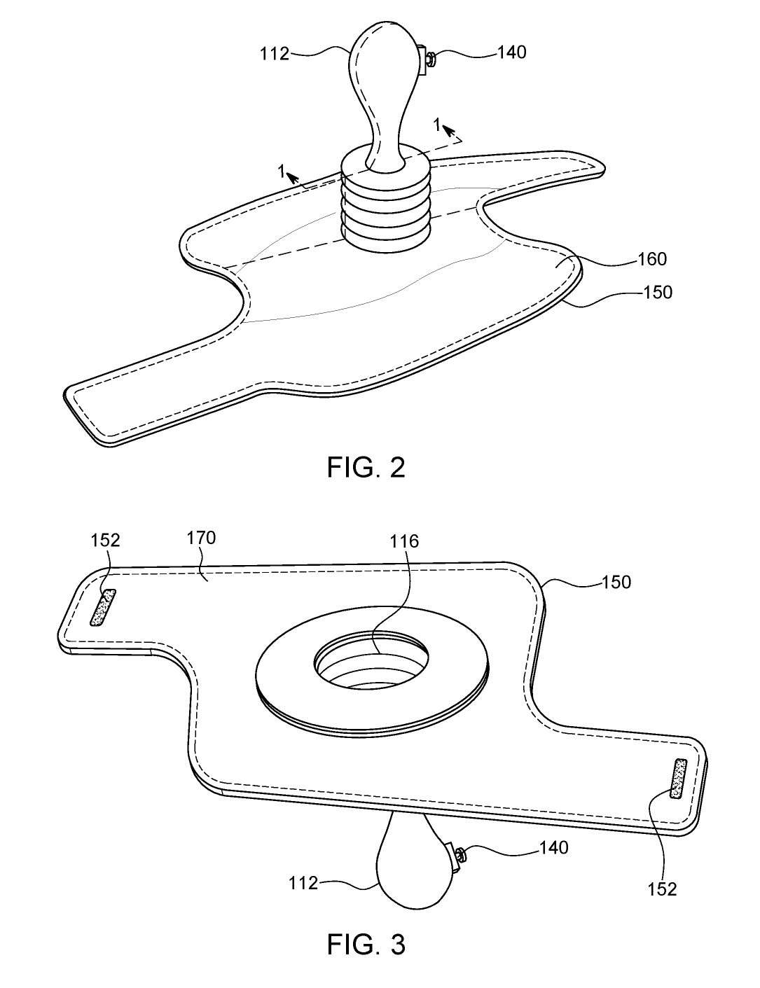

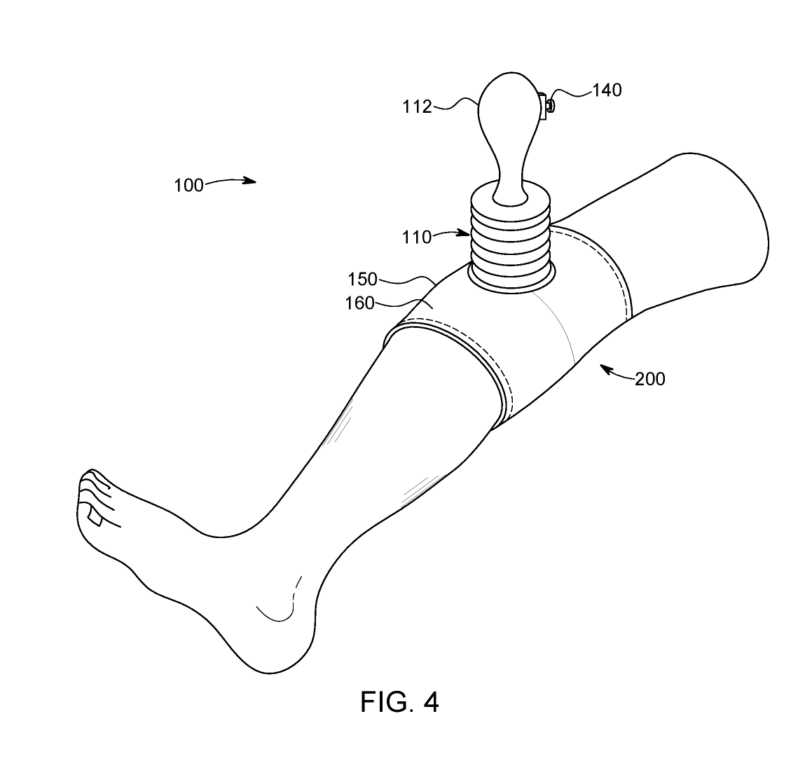

Turning to FIG. 2 and FIG. 3, a top perspective view and bottom perspective view of an embodiment of apparatus 100 is shown. Brace 150 is configured to secure around a human appendage, such as a leg, arm, knee, ankle, or elbow and made of natural or synthetic fabric and can be secured using Velcro 152, snaps, buttons, hooks, or other commonly used mechanisms for securing fabric around a human appendage. To further illustrate the apparatus, FIG. 4 shows a top perspective view of an embodiment of apparatus 100 secured to a treatment area ready for a therapy session to commence.

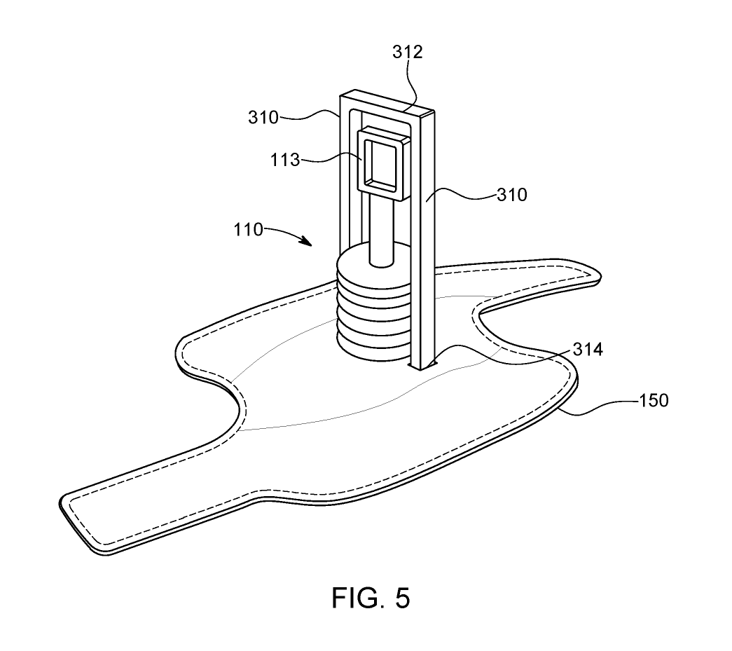

Turning to FIG. 5, a side view of an embodiment of apparatus 100 is shown. Apparatus 100 comprises a vacuum chamber 110 which further comprises handle 113, a first gasket 120, a second gasket 130, a pressure relief valve 140, a brace 150, and a stabilizer bar 300. Stabilizer bar 300 provides a way for a user to create a mechanical advantage through leverage, thereby making manipulation of handle 113, and thus application of directional vacuum pressure to a treatment area easier for the user. It is contemplated handle 113 could be other shapes which easily allow a user to create the desired mechanical advantage. Stabilizer bar 300 is useful for a user who may be elderly, in a weakened condition, or finds it difficult to push or pull handle 112 to perform therapy without the aid of bar 300. Stabilizer bar 300 is separate and independent from vacuum chamber 110 and comprises at least two vertical lengths 310 and a horizontal length 312. Vertical lengths 310 further comprise a connection point 314 on one end of each length 310 which connect to brace 150 and connect to horizontal length 312 at the other end of each vertical length 310 at preferably a 90 degree angle. Vertical lengths 310 each connect to one side of horizontal length 312. In the preferred embodiment vertical lengths 310 and horizontal length 312 are formed integrally together as one piece. Vertical lengths 310 and horizontal length 312 may be made of any strong, lightweight, and washable material such as plastic, one preferred material is nylon. Further, vertical lengths 310 and horizontal length 312 are preferably tubular in shape but may be square, triangular, or other geometric or ergonomic shapes convenient for a user to grasp and hold onto. Vertical lengths 310 are preferably at least 6.6 inches long and 0.25 inches in diameter and horizontal length 312 is preferably at least 3.8 inches long and 0.25 inches in diameter, however the dimensions may be altered to accommodate an apparatus 100 of different proportions then disclosed above. Further, stabilizer bar 300 may be secured to brace 150 at connection points 314 by adhesive, sewing, snaps, buttons, Velcro, or any other attachment manner which is known to attach plastic to fabric securely to resist a pulling force exerted by the hand of an average adult human.

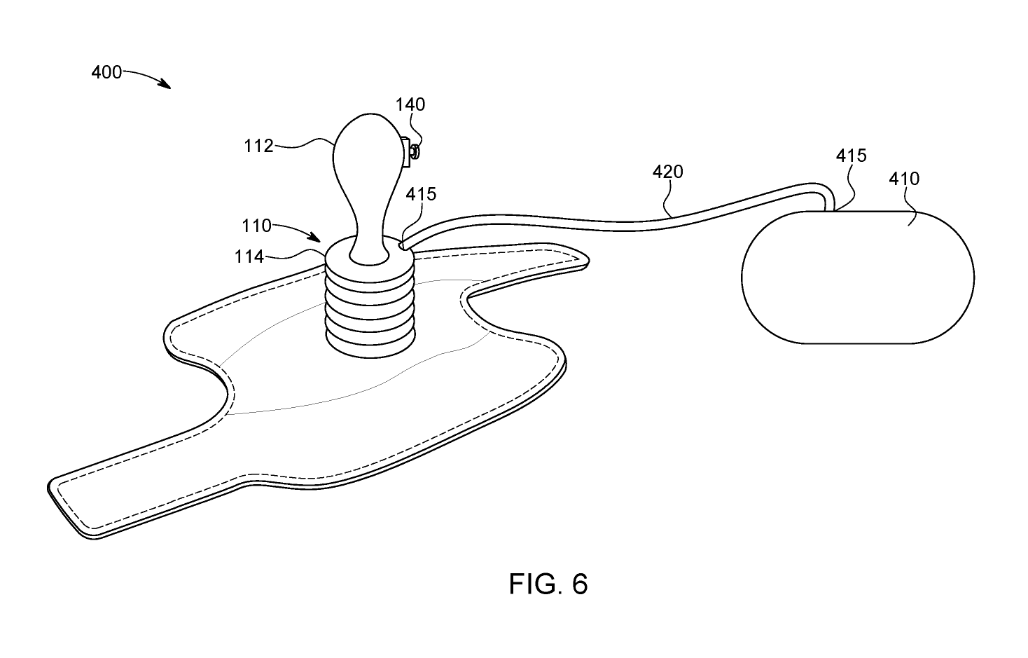

Turning to FIG. 6, an embodiment of a manual manipulation therapy system 400 comprising apparatus 100, vacuum pump 410, and a tube 420 is disclosed which provides automated vacuum pressure application to a treatment area, thereby freeing a user to focus on controlling the direction of the vacuum pressure applied to the treatment area. In this system, apparatus 100 further comprises at least one tube connection 415 affixed to vacuum chamber handle 112 or air cavity 114 in a location which does not impede a user from performing manual manipulation therapy via handle 112 or interfere with the intended purpose or effectiveness of vacuum chamber 110 in creating and maintaining a vacuum pressure at the treatment site. The preferred location of tube connection 415 is on closed end 142 of air cavity 114. Further, it is contemplated tube connection 415 may, if desired, replace pressure relief valve 140 in location, wherein allowing vacuum pump 410 to replace the function of valve 140. Tube connection 415 can be made of any material and configuration common in the art to secure a hose to an apparatus for the purpose of providing a vacuum such as a 90 degree elbow bend, but a 0.25 inch quick-connect female connection for 0.25 inch outer diameter tube 420 is preferred. It is contemplated fittings of other diameter sizes can be used to accommodate different diameters of tube 420. Further, the same tube connection type could be used to connect tubing 420 to vacuum pump 410. Tubing 420 removably connects apparatus 100 to vacuum pump 410 and provides a way for vacuum pump 410 to create and maintain a vacuum within the vacuum chamber of apparatus 100 at the desired level. Tubing 420 can be any length, composition, and diameter desired as long as a vacuum of at least 1 PSIV can be established and maintained within the tubing. A preferred composition would be made from polyvinyl chloride and be bisphenol A (BPA) free. Vacuum pump 410 creates and maintains a vacuum within vacuum chamber 110 of apparatus 100 when it is applied to a treatment area and may be a manual hand pump, a mechanically driven pump, or an electromechanical driven pump. Vacuum pump 410 could further be controlled by a control system, such as a computer, microcontroller, timer circuit, or other commonly used ways to create, maintain, and control a vacuum pressure of at least 1 PSIV. It is contemplated such vacuum pump 410 could be capable of operating in a preconfigured manner desirable for manual manipulation therapy. For example, it has been found a therapy session comprising five sets of manual manipulation of a kneecap (that is providing a vacuum pressure of at least 1 PSIV in at least one direction to a treatment area) in one second intervals for thirty seconds produced a noticeable reduction in pain in the treatment area of an individual.

Last, a method is disclosed to manually manipulate an area of a human appendage by first securing a manipulation therapy apparatus comprising a vacuum chamber with a handle, a first gasket, second gasket, a pressure release valve, and a wrap on a treatment area to a human appendage, then centering the vacuum chamber over a treatment area on the appendage, followed by securing the wrap around the appendage, pushing down on the vacuum chamber via the handle to evacuate air inside the chamber, and then pulling the handle in at least one direction for a period of time to manipulate the treatment area. It is contemplated a user could perform the step of pushing down on the vacuum chamber via the handle to evacuate air inside the chamber or pulling the handle in at least one direction for a period of time to manipulate the treatment area as could a machine, such as a vacuum pump or electronic or computerized control system as described therein.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

The terms 3M® and Super 77® are registered United States trademarks of 3M Company of Saint Paul, Minn., USA.

What is claimed is:

1. A manipulation therapy apparatus comprising:
a vacuum chamber further comprising a handle cavity connected to an air cavity having a closed end and an open end, wherein the open end further comprises an outward facing lip;
a first gasket of a first durometer affixed to the top of the outward facing lip;
a second gasket of a second durometer affixed to the bottom of the outward facing lip; and
a fabric brace configured to wrap firmly around a human appendage further comprising a top surface, a bottom surface, and a recess configured for holding materials, wherein the handle cavity and air cavity of the vacuum chamber extend through the recess away from the top surface while the first gasket touches the bottom surface and extends away from the bottom surface along with the second gasket and the outward facing lip.

2. A manipulation therapy apparatus according to claim 1, wherein the apparatus further comprises a pressure relief valve affixed to the vacuum chamber.

3. A manipulation therapy apparatus according to claim 1, wherein the recess configured for holding materials is at least the size of the inner diameter of the air cavity and less than the outer diameter of the first circular gasket.

4. A manipulation therapy apparatus according to claim 1, wherein the first gasket has a smaller outer diameter than the second gasket.

5. A manipulation therapy apparatus according to claim 1, wherein the apparatus further comprises a tube connector affixed to the vacuum chamber.

6. A manipulation therapy apparatus according to claim 1, wherein the air cavity is a tubular bellows shape.

7. A manipulation therapy apparatus according to claim 1, wherein the pressure relief valve is located on the handle.

8. A manipulation therapy apparatus according to claim 1, wherein the first gasket durometer is greater than the second gasket durometer.

9. A manipulation therapy apparatus according to claim 1, wherein the apparatus further comprises a stabilizer bar located next to but separate from the vacuum chamber and affixed to the brace.

10. A stabilizer bar according to claim 10, where the stabilizer bar is further comprised of at least two vertical lengths and a horizontal length, wherein one side of each vertical length is connected to an end of the horizontal length.

11. A manipulation therapy apparatus comprising:
a vacuum chamber further comprising a manner to provide traction to the skin of a treatment area and an air cavity having a closed end and an open end, wherein the open end further comprises an outward facing lip;
a manner for sealing the bottom of the outward facing lip to the skin of the treatment area; a brace configured to wrap firmly around a human appendage further comprising a top surface, a bottom surface, and a recess configured for holding materials, wherein the manner to provide traction and air cavity of the vacuum chamber extend through the recess in the brace away from the top surface while manner for sealing touches the bottom surface of the brace and extends away from the bottom surface and the outward facing lip.

12. A manipulation therapy apparatus according to claim 11, wherein the apparatus further comprises a pressure relief valve affixed to the vacuum chamber.

13. A manipulation therapy apparatus according to claim 11, wherein the manner for sealing is a gasket.

14. A manipulation therapy apparatus according to claim 11, wherein the manner to provide traction is a handle.

15. A system for manual manipulation of a human appendage comprising:
a manipulation therapy apparatus comprising:
a vacuum chamber further comprising a handle cavity formed connected to an air cavity having an open end, wherein the open end comprises an outward facing lip;
a first gasket of a first durometer affixed to the top of the outward facing lip;
a second gasket of a second durometer affixed to the bottom of the outward facing lip, a tube connection affixed to the vacuum chamber; and
a fabric brace configured to wrap firmly around a human appendage further comprising a top surface, a bottom surface, and a recess configured for holding materials, wherein the handle cavity and air cavity of the vacuum chamber extend through the recess away from the top surface while the first gasket touches the bottom surface and extends away from the bottom surface along with the circular gasket and the outward facing lip;
a vacuum pump configured to create and maintain a vacuum within the vacuum chamber of the manipulation therapy apparatus; and
a tube, wherein one end of the tube removably connects to the vacuum chamber and the other end connects to the vacuum pump.

16. A system manual manipulation of a human appendage comprising appendage in claim 15, wherein the vacuum pump is configured to create vacuum pressure inside the vacuum chamber of the manipulation therapy apparatus for a preconfigured quantity of at least one quantity and at least one duration of time.

17. A system manual manipulation of a human appendage in claim 15, wherein the vacuum pump is operated by manual, mechanical, or electromechanical force.

18. A system manual manipulation of a human appendage in claim 15, wherein the vacuum pump is controlled by a microcontroller.

19. A system manual manipulation of a human appendage in claim 15, wherein the first gasket durometer is greater than the second gasket durometer.

20. A system manual manipulation of a human appendage in claim 15, wherein the manipulation therapy apparatus further comprises a pressure relief valve affixed to the vacuum chamber;

21. A method to manually manipulate an area on the surface of a human appendage without using a lubricant comprising: securing a manipulation therapy apparatus comprising a vacuum chamber further comprising a handle and an air cavity, a first gasket, second gasket, a pressure release valve, and a wrap on a treatment area to a human appendage, centering the vacuum chamber over a treatment area of the appendage; securing the wrap around the appendage; pushing down on the vacuum chamber via the handle to evacuate air inside the chamber; and pulling the handle in at least one direction for a period of time to manipulate the treatment area.

22. A method to manually manipulate an area on the surface of a human appendage without using a lubricant in claim 21, wherein pushing down on the vacuum chamber on the vacuum chamber via the handle is completed by a vacuum pump.
